(19) United States
(12) Patent Application Publication
(10) Pub. No.: US 2019/0122831 A1
(43) Pub. Date: Apr. 25, 2019

(54) ELECTRICAL RELAY

(71) Applicant: Albright International Limited, Whitchurch (GB)

(72) Inventor: Nigel Edward Lawrence BEDGGOOD, Whitchurch (GB)

(21) Appl. No.: 16/168,175

(22) Filed: Oct. 23, 2018

(30) Foreign Application Priority Data
Oct. 24, 2017 (GB) 1717468.1

(51) Int. Cl. H01H 3/00; H01H 50/54; H01H 1/18

(52) U.S. Cl. CPC H01H 3/001; H01H 1/18; H01H 50/546

(57) ABSTRACT

The present invention relates to the field of heavy duty relays with electromagnetic, pneumatic or other mechanical means of actuation. In particular the invention relates to a relay or contactor which addresses the problem of contact welds formed during actuation of the relay. In one aspect the invention provides an electrical relay comprising a contact bridge portion carrying at least two spaced apart electrical contact surfaces, a terminal portion comprising at least two corresponding spaced apart electrical contact surfaces, and an actuating mechanism for selectively bringing the electrical contact surfaces of the bridge portion into electrical contact.

### RELATED APPLICATIONS

This application claims priority under 35 U.S.C. § 119 to United Kingdom Patent Application No. 1717468.1, filed on Oct. 24, 2017 and titled, “Electrical Relay,” which is hereby incorporated by reference in its entirety.

### TECHNICAL FIELD

The present invention relates to the field of heavy duty relays (also known as contactors) with electromagnetic, pneumatic, mechanical or other means of actuation. In particular the invention relates to a relay or contactor which addresses the problem of contact welds formed during actuation of the relay.

### BRIEF DESCRIPTION OF THE DRAWINGS

Following is a description by way of example only and with reference to the drawings hereinafter of modes for putting the present invention into effect.

In the drawings:—

FIG. 1 is a three quarter perspective view, partially cut-open, showing an electromagnetically actuated contactor.

FIG. 2 is a schematic side view of a contact bridge assembly which is part of the electrical contacting mechanism of the contactor of FIG. 1.

FIG. 3 is a schematic end-on view of the contact bridge assembly.

FIG. 4a is a schematic side view of an embodiment of contact pad arrangements on the bridge and contact studs.

FIG. 4b is a schematic side view of another embodiment of contact pad arrangements on the bridge and contact studs

FIG. 4c is a schematic side view of another embodiment of contact pad arrangements on the bridge and contact studs.

FIG. 5 is an exploded three quarter perspective view of a contact bridge and plunger assembly for use in a first embodiment the present invention.

FIG. 5a is a detail view of a portion of the assembly of FIG. 5.

FIG. 6a is a schematic end-on view of the plunger and bridge member assembly.

FIG. 6a′ is detail view of a portion of the assembly of FIG. 6a.

FIG. 6b is a schematic side view of the plunger and bridge member assembly.

FIG. 7 is a schematic end-on view of the contact bridge and plunger assembly shown in FIG. 6 located in a contactor such as that shown in FIG. 1, the assembly in a first configuration of plunger displacement.

FIG. 8 is a schematic end-on view of the assembly of FIG. 7 in a second configuration of relatively longer plunger displacement (upwards) with respect to the configuration of FIG. 7.

FIG. 9 is a schematic end-on view of the assembly of FIG. 7 in a third configuration of relatively longer plunger displacement (upwards) with respect to the configuration of FIG. 8.

FIG. 10 is a schematic end-on view of the assembly of FIG. 7 in a fourth configuration of relatively longer plunger displacement (upwards) with respect to the configuration of FIG. 9.

FIG. 11 is an exploded three quarter perspective view of a contact bridge and plunger assembly for use in a second embodiment the present invention.

FIG. 12 is a schematic end-on views of the contact bridge and plunger assembly shown in FIG. 11 located in a contactor such as that shown in FIG. 1, the assembly in a first configuration.

FIG. 13 is a schematic end-on views of the contact bridge and plunger assembly shown in FIG. 11 located in a contactor such as that shown in FIG. 1, the assembly in a second configuration.

FIG. 14 is a schematic end-on views of the contact bridge and plunger assembly shown in FIG. 11 located in a contactor such as that shown in FIG. 1, the assembly in a third configuration.

FIG. 15 is a schematic end-on views of the contact bridge and plunger assembly shown in FIG. 11 located in a contactor such as that shown in FIG. 1, the assembly in a fourth configuration.

FIG. 16 is an exploded three quarter perspective view of a contact bridge member and plunger assembly for use in a third embodiment of the invention.

### DETAILED DESCRIPTION

It is recognised that heavy duty electrical relays or contactors can experience contact welding or contact sticking. This can result in contacts remaining closed when they should be open and this in itself can lead to potentially dangerous situations with circuits remaining live when they should be dead.

Contact welding can be caused by a variety of situations or circumstances for example: contacts closing on high currents with fast rise times, hesitation during opening or closing of the contacts, the presence of an inherently weldable contact material (for example copper or unmodified silver), shock and vibration, etc.

Generally, during the normal closing operation contacts bounce open and closed several times, and this cycle of bouncing open and closed typically occurs over several milliseconds. It can be seen that if a high current flows during this bounce cycle, multiple arcs may be drawn, culminating in a globule of molten contact material at the contact point such that when the bouncing stops, the globule solidifies resulting in a weld between the two contact faces.

Traditional single break relays and contactors, popularly known as ‘clapper’ types, have overcome this situation because their hinged construction allows them to incorporate a rolling or wiping contact which inhibits a weld in the first place and mechanically breaks a weld should one occur. However this configuration tends to make the relays bulky and their single break contact is less efficient at extinguishing arcs compared with the more compact double or multiple break types which are more prevalent with modern electrical control systems.

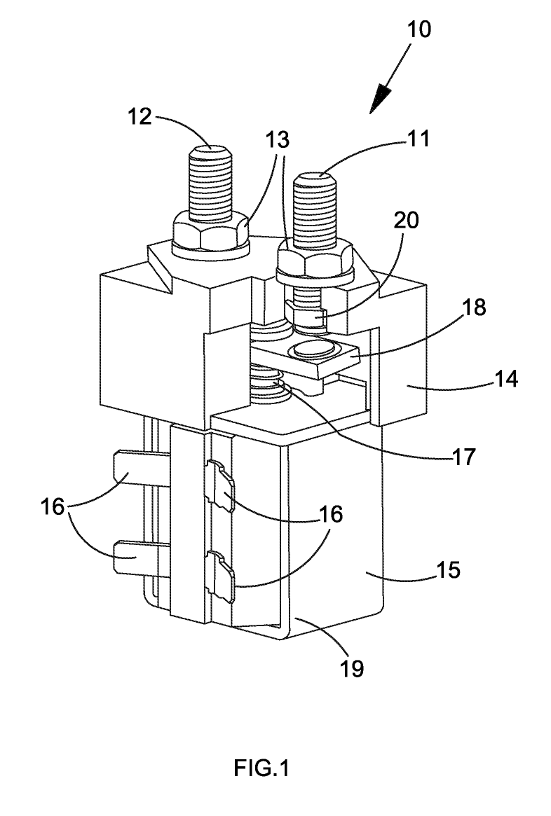

A double break relay or contactor usually comprises a moveable bridge which carries two spaced apart contact regions which when energised by a motive force such as an electromagnetic coil, a pneumatic cylinder or other mechanical device, makes an electrical contact with two correspondingly spaced apart fixed contact posts, as shown in FIG. 1.

When the moveable bridge is at rest, i.e. not making contact, it can be seen that there are two contact gaps, one between each fixed post and each bridge contact region—hence the terminology ‘double break’. A disadvantage of double break contactors is that when their contacts bounce during the closing cycle, the actual contact points remain in approximately the same position (axially aligned) during the bounce period, whereas with the aforementioned single break clapper type of contactor, the contact point moves with respect to surface of the contact. Thus there can be a tendency for the contacts of a double break contactor to remain closed, if weldable conditions prevail.

US 2011/0279202 discloses an electromagnetic switch in which a contact plate is formed with an elbow so that when a contact is made at the end of the contact plate, deformation of the plate causes the end to splay outwards slightly which causes the contact point to travel outwards, thereby scraping the underlying contact surface so as to ensure that a good electrical contact is made.

The present invention seeks to address the problem of device failure by contact welding in relays, and in particular in axial travel relays, especially moving bridge relays.

According to one aspect of the invention there is provided an electrical relay comprising a first member, a second member and an actuating mechanism for selectively bringing the first member into electrical contact with the second member by travel along an approach path between the members, wherein the first and second members are provided with at least one corresponding pair of associated electrical contact surfaces for making the electrical contact. These electrical contact surfaces are oriented with respect to the approach path and one another so as to be capable of forming a face to face abutment when brought into electrical contact.

At least one electrical contact surface of one member is tilted by means of resilient biasing means relative to the corresponding electrical contact surface of the other member so that as the electrical contact surfaces are brought together along the approach path the electrical contact surfaces make an initial contact in the tilted orientation and as the members travel progressively together the movement of one member towards the other counteracts the biasing means so that the tilt reduces until face-face square-on contact is obtained as the surfaces are urged together in electrical contact.

The degree of tilt may be chosen according to the implementation required, but a preferred angle is 12 degrees from the horizontal (i.e. with respect to the orientation of the face of the contact with which the tilted contact will abut/interface). Other angles are of course possible and tilts within the range of 1 to 30 degrees, preferably 2 to 20 degrees, have been found to be useful.

The electrical contact surfaces may each be oriented so as to be generally perpendicular in orientation with respect to the approach path, subject to any applied tilt. At least one of the electrical contact surfaces may be tilted by biasing away from the perpendicular orientation.

The first member may be a travelling contact member responsive to relay activation. The second member may be a fixed member, such as a terminal or terminal stud, up to which the contact member travels on actuation.

In another, related, aspect of the invention there is provided an electrical relay comprising a contact bridge portion carrying at least two spaced apart electrical contact surfaces, a terminal portion comprising at least two corresponding spaced apart electrical contact surfaces, and an actuating mechanism for selectively bringing the electrical contact surfaces of the bridge portion into electrical contact with the electrical contact surfaces of the terminal portion by travel of one portion with respect to the other portion along an approach path between the portions, wherein the electrical contact surfaces of one portion are oriented with respect to the approach path and the electrical contacts of the other portion so as to be capable of forming a face-to-face abutment between electrical contact surfaces of the respective bridge and terminal portions.

At least one electrical contact surface of one portion is tilted by means of resilient biasing means relative to the corresponding electrical contact surface of the other portion so that as the electrical contact surfaces are brought together along the approach path the electrical contact surfaces make an initial contact in the tilted orientation and as the portions travel progressively together the movement of one member towards the other counteracts the biasing means so that the tilt reduces until face-to-face square-on contact is obtained as the surfaces are urged together in electrical contact.

The approach path is preferably a straight longitudinal displacement axis between first and second bridging and terminal members (or respective bridging and terminal portions).

The electrical contact surfaces may each be oriented so as to be generally perpendicular in orientation with respect to the approach path, subject to any applied tilt. At least one of the electrical contact surfaces is preferably tilted by biasing away from the perpendicular orientation.

The bridge portion may be provided with two spaced-apart contact surfaces, and there are two corresponding fixed terminal members in the terminal portion across which a circuit is made on actuation.

In a preferred arrangement, the actuation mechanism includes an actuation plunger which is attached to the bridge portion, the plunger being arranged so as to be axially displaced along the approach path in response to actuation, and thereby to displace the bridge portion into electrical contact. The approach path may comprise an actuation plunger longitudinal displacement axis.

The bridge portion may comprise a bridge member which carries the two spaced apart contacts, which contacts are disposed generally perpendicular to the plunger displacement direction. The bridge member may be arranged to be capable of limited tilting with respect to the plunger, so that the electrical contact surfaces can tilt with the bridge member relative to the plunger travel direction.

The bridge member may be provided with a bore in which is accommodated the plunger with a loose fit which permits tilting of the bridge member with respect to the plunger. The biasing means is preferably operative between the plunger and bridge member so as to urge the bridging member into a tilted orientation. The bore typically extends in the approach path direction (so as to permit plunger travel in that direction) and is disposed in a central region of the bridging member, which member is disposed transversely with respect to the plunger.

In a preferred arrangement a protruding feature is provided which is operative between the plunger and bridging member, which protruding feature displaces the bridging member from a perpendicular orientation to the tilted orientation. The protruding feature may be disposed on the plunger so as to act on the bridging member. Alternatively the protruding feature may be disposed on the bridging member so as to act against the plunger. The protruding feature may be a nub or block which acts to tilt the bridging member. The protruding feature may comprise a feature having a wedge profile. In a preferred arrangement protruding feature is a wedge profile washer having a central bore for the plunger.

The biasing means may also include a spring (preferably a coil spring) which acts to urge against the bridging member, which is this maintained tilted with respect to the plunger. The coil spring may accommodate a lower region of the plunger within its coil and may be held on the plunger by a retainer such as a spring clip or fixed washer.

The actuation mechanism may be any such arrangement known in the art and such as will be known to persons skilled in the art. For example, the mechanism may comprise one or more of: an electromagnet, a solenoid, a pneumatic actuator, a motor or a mechanical lever or button.

The electrical contact surfaces are typically provided by generally planar contact pads. One or more of the electrical contact surfaces or pads may have a domed configuration. Preferably at least one of each of the interfacing pairs of electrical contacts is domed. More preferably both of each interfacing pairs are domed. The dome profile radius (over a diametric section) can be chosen according to the requirements for the device, but by way of example a 100 mm radius to the dome profile has been found to be useful. The rocking, rolling and/or sliding/wiping action which takes place on forming electrical contact using the inventive relays or contactors is described in more detail hereinafter.

The pads can have any plan shape, for example circular, square, rectangular, other regular shaped or irregular shapes.

The pads are typically made of metallic material which is fixed onto an underlying substrate (e.g. terminal stud or bridge member) by welding, braising or soldering or riveting. Preferred pad materials are silver or silver alloys (as are known in the art) although other materials are possible such as copper or copper alloy. The pads may be integrated into, or unitary with, the contact carrier, whether the carrier is fixed or moving. So the pad may be formed integrally as a moulded, cast or forged feature, or a machined feature. Copper or copper alloys are preferred for integrated/unitary pads.

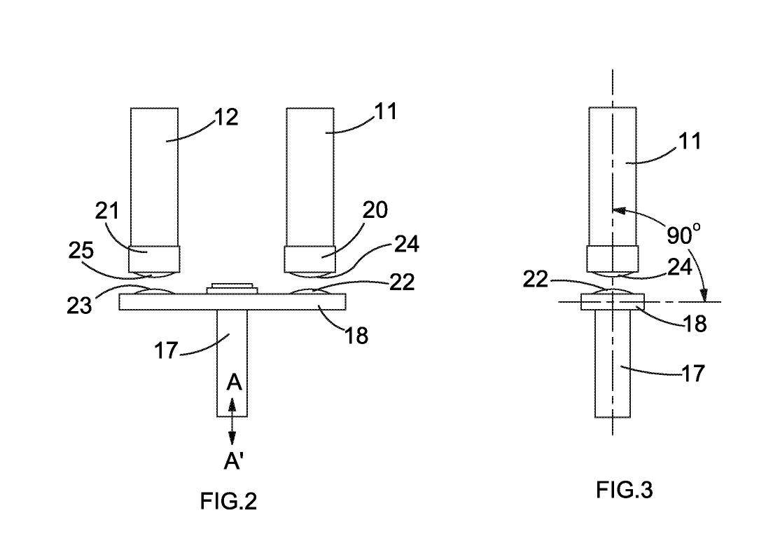

FIG. 1 shows an electromagnetically actuated DC contactor 10 (such as, for example, the SW80 available from Albright International, Hampshire, UK). The device has two fixed terminals in the form of upstanding screw-threaded studs 11, 12, each provided with a corresponding nut 13. An upper housing portion 14 is made of insulating plastics material and is provided with two vertical bores for accommodating lower regions of the screw threaded studs. A lower housing portion 15 includes a magnet frame 19 and coil (not visible). Four coil connections protrude from the side of the housing as spade contacts 16. The contacts, when appropriately energised, cause an internal vertical plunger 17 with attached transverse, elongate rectangular section contact bridge member 18, to travel upwards to form an electrical contact with the contact caps 20, 21 provided at the lower ends of the studs 11, 12. This is best seen in the schematic view FIG. 2. On energising of the coil, the plunger A is urged upwards and travels in the direction A. This moves the contact bridge member 18 upwards so that upwardly facing contact pads 22, 23 carried on the end regions of the contact bridge approach and contact corresponding downwardly facing contact pads 24, 25 on the lower ends of the contact caps 20, 21 of the terminal studs 11, 12. Thus an electrical contact bridge is made across the stud terminals. As shown in FIG. 3 the contact studs 11 and plunger 17 are vertically aligned, with the bridge member 18 oriented perpendicularly with respect to the plunger.

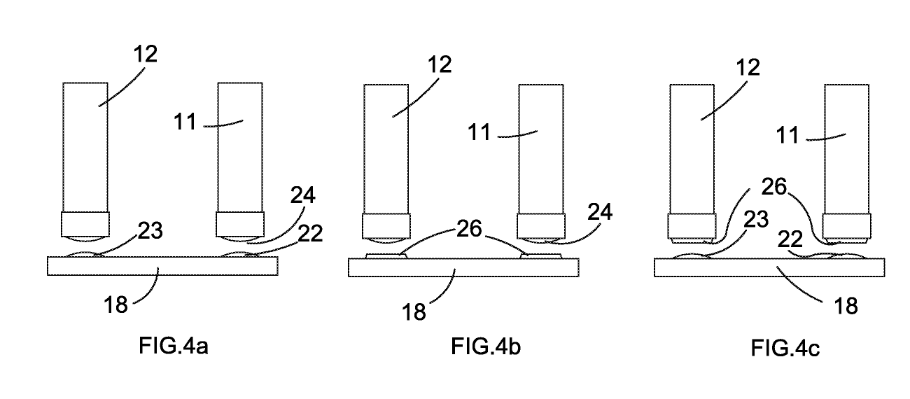

The contact pads may be any suitable shape. In FIG. 4a the contacts are all slightly domed. In the embodiments of FIGS. 4b and 4c they are circular discs 26 on one face and domed on the other.

### First Embodiment

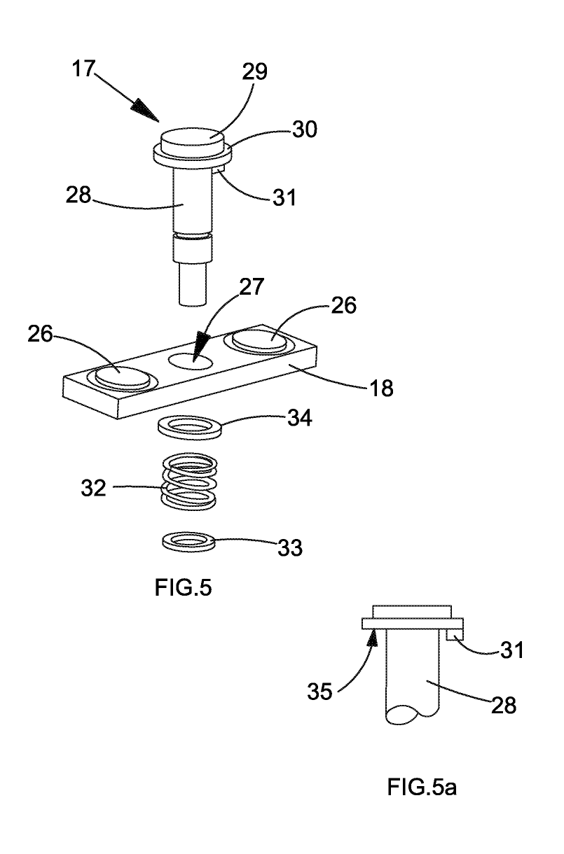

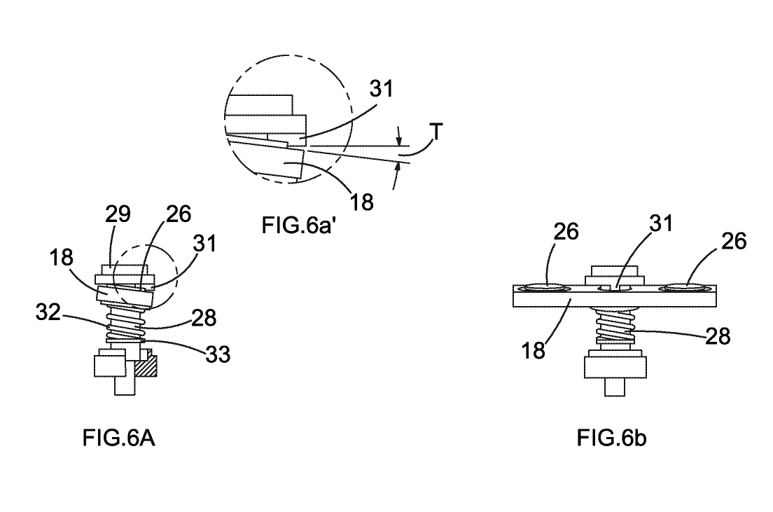

FIG. 5 shows the contact bridge member 18 and plunger 17 assembly in accordance with the invention. The contact bridge member has a centrally located vertical bore 27, which is slightly oversize (in diameter) with respect to the outside diameter of the cylindrical body 28 of the plunger. The plunger has a head region 29 which is provided with an annular step 30. An annular underside face 35 of the head region is provided with a downwardly and radially projecting block 31 at an outer region thereof. The plunger is accommodated in the central bore with the head region on an upper side of the bridge and the cylindrical body portion projecting through the bore underneath the bridge. The plunger is urged against the upper side of the bridge by a coiled compression spring 32 and C-clip spring retainer 33, as shown in FIGS. 6a and 6b. An insulating annular spacer 34 isolates the spring from the bridge member.

Because of the oversize bore the bridge member can wobble or tilt somewhat with respect to the plunger. Thus the block 31 prevents the bridge member from sitting square with respect to the plunger head underside face 35 whilst urged by the spring 32. The bridge member 18 thereby sits tilted (about its longitudinal axis) with respect to the plane orthogonal to the plunger travel axis (i.e. tilted with respect to the horizontal plane) by a tilt angle T shown in FIG. 6a′. So the angle T depends upon the depth (D) of the (inside edge of) block 31 and the width (W) of the bridge member, per sin (T)=D/W. In this example the tilt angle is 12 degrees. Because the bridge member is tilted the contact pads carried on the upper surface of the bridge member are also tilted (as shown in FIG. 6b). The bridge member is biased by the coil spring so that in the absence of an external action it maintains a tilted orientation.

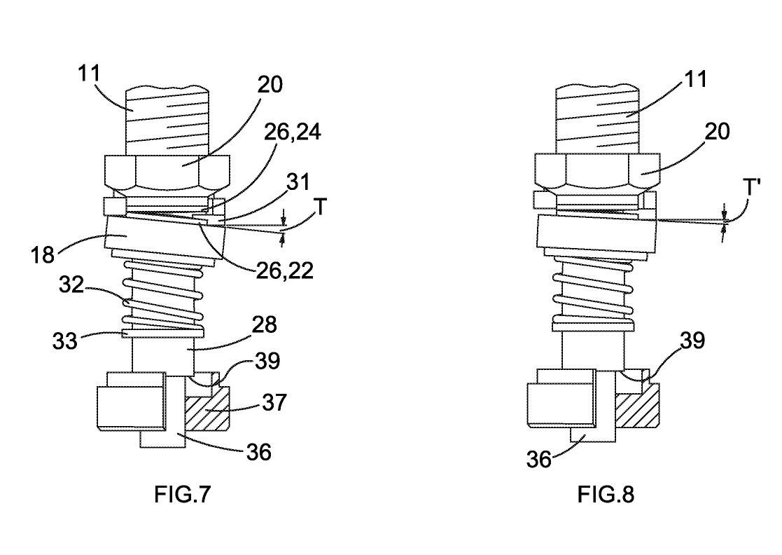

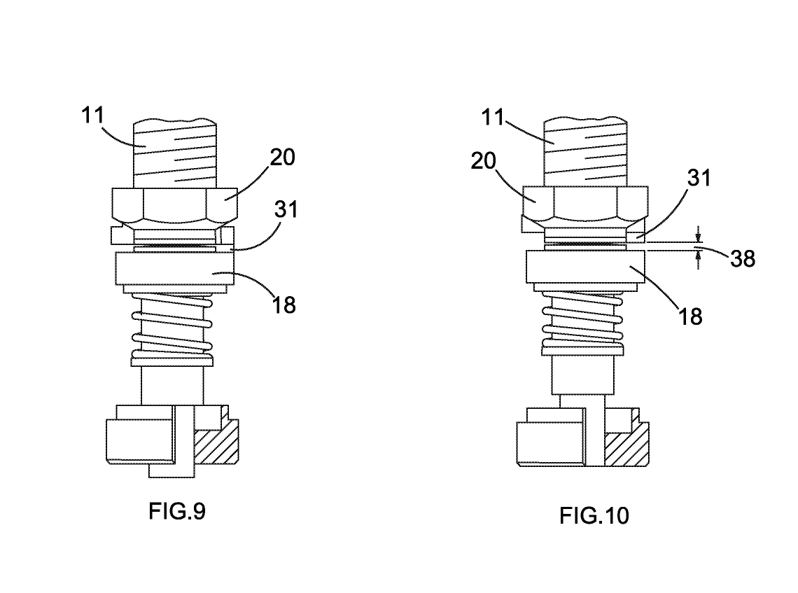

In FIG. 7 a plunger 17 and the contact bridge member 18 assembly are essentially as described in relation to FIGS. 5 and 6 is shown. The plunger lower end region has a shoulder 39 and relatively narrow spigot portion 36 which is a sliding fit in a generally annular steel bush 37. The annular shoulder 39 limits the extent to which the plunger can descend. In FIG. 7 the plunger is shown displaced vertically in response to an electromagnetic impulse provided by an activation coil (not shown). The lower contact pad 22 on the tilted contact bridge approaches the corresponding contact pad 24 on the underside of the contact cap 20 in a yawed orientation (represented by tilt T). Because of this the peripheral circumferential edges of each (upper and lower) contact pad meet first as the contacts touch. As the plunger travels further upwards (see FIG. 8) the constraint offered by the fixed stud 11 (and associated cap 20 and contact pad 24) means that the contact bridge is gradually deflected back towards the horizontal (perpendicular). Thus the effective contact surface rolls inwards across the contact pads towards the centre of the pad surfaces, as the tilt angle T′ reduces (T′<T). With further vertical displacement (FIG. 9) the contact pads squarely abut one another with the bridge member now fully centred (i.e. the tilt is zero). The plunger is permitted a small amount of vertical displacement overrun 38 (in FIG. 10) which means that the coil spring maintains the contact pads (including the second pad pair not visible in FIGS. 7 to 10) urged strongly together, so as to help prevent bridge member bounce (and associated momentary loss of contact and possible arcing).

In accordance with the present invention it will be seen that by ensuring that the contact pads do not approach and contact square on, but in fact tilted with respect to one another, a contact is made which gradually travels across from the edge of the pads to the centre. This means that arcing across the pad surfaces during the contact stroke is less likely to occur than when the pads approach square on when a uniform, decreasing separation distance is maintained across each pad.

It will be appreciated that when one or both interfacing contact pads have a domed configuration the interfacing contact area can be made to roll (or travel) radially across the contact pads from the periphery to the centre. This means that if an initial arc and weld should be made at the one contact region, this weld will be broken (separated) as the contact rolls away.

In addition, if the dome radius or curvature is selected appropriately a sliding (or scraping) contact will be made, in which one pad contact area slides with respect to the other as the tilt is reduced. This sliding/scraping serves to ensure that a good contact is made and shears any transitory welds between the contact pads during the plunger contact stroke.

It will be understood that on breaking the electrical contacts (by retraction of the plunger) the tilting, rolling and sliding actions happen in reverse, which can act to break any weld, clean oxide or detritus or limit the propensity of arcing during retraction.

### Second Embodiment

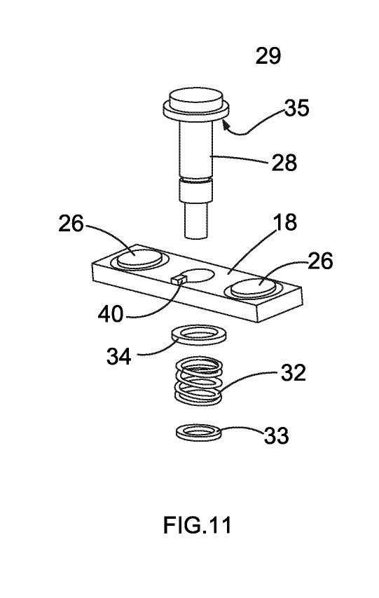

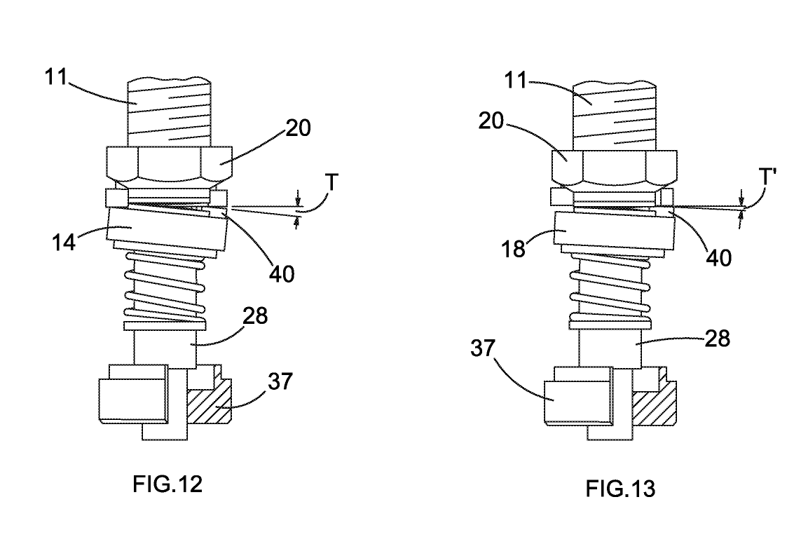

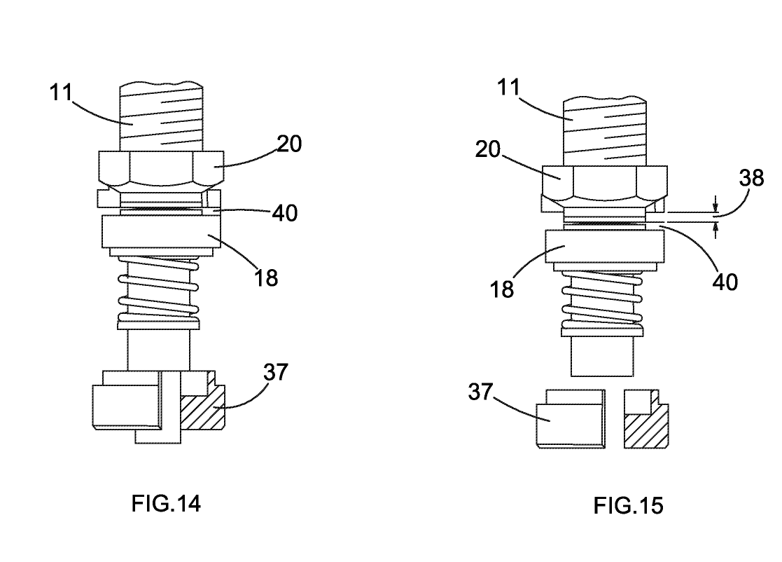

A second embodiment of the invention is now described with reference to FIGS. 11 to 15, in which common components or features also present in the first embodiment are given identical numbering. In this variant, rather than a downwardly projecting block 31 acting to tilt the bridging member 18, the bridging member 18 is provided with an upwardly projecting block 40 as shown in FIG. 11. The block is disposed at one side of the central bore through the bridging member. The plunger head region 29 has an annular underside face 35 which omits any downward projection. In this case the block is urged against the underside face 35 of the plunger which causes the bridging member to tilt (as permitted by the oversize bore tolerance) about its longitudinal axis, causing the bridge member's contact pads to be tilted with respect to the fixed contact pads attached to the underside of the studs 11, 12. Except as set out above, this device operates in the same way as that of the first embodiment.

### Third Embodiment

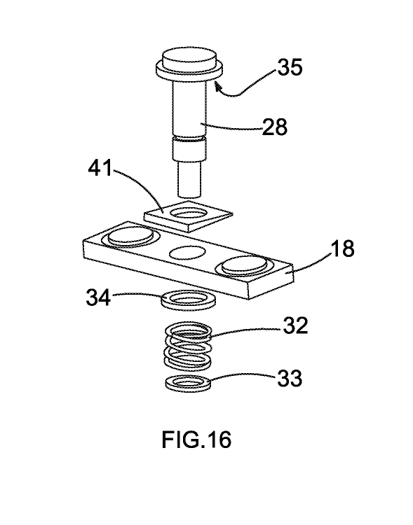

In this embodiment the components are as previously described for the first and second embodiments, but without the respective projecting blocks 31 and 40. There is however instead a wedge shaped washer 41 (as shown in FIG. 16) which is interposed between the plunger head underside face 35 and the upper surface of the contact bridge member 18. The wedge washer has a bore for the plunger to pass, as a loose fit. In use the coils spring 32 urges upwards against the bridge member, with the wedge causing the bridge to adopt a tilted orientation. The degree of tilt is dictated by the apex angle of the wedge. As for embodiments 1 and 2, the contacts carried by the bridge member 18 will be tilted relative to those of the fixed studs, causing contact to be made away from the centre first and then close across the centre of the contact pads.

Provided a wedge profile is present any plan configuration of wedge can be used, such as generally circular, rectangular, square or irregular shapes, for example.

In other embodiments the wedge could be fixed to (or form a surface feature of) the underside surface 35 of the plunger. Alternatively the wedge could be fixed to (or form a surface feature of) the upper surface of the bridge member 18.

Other ways of achieving a tilted bridge and contacts are of course possible and the invention is not limited to the methods of the specific embodiments described above.

By way of summary, essentially the invention relies upon the contact pads of the moveable bridge and those of the contact posts initially to make contact away from the centre of the normal contact position. Typically this would be at the edges or near the edges of the contacts. This is achieved by setting the moveable (travelling) contact pads at an angle of a little more or less other than 90 degrees (perpendicular) to the direction of travel of the interfacing contact pads. Conventionally a contactor having double breaking contacts has a moveable contact (on a bridging member) which bridges two fixed contacts thus completing a circuit. The motive force for the moveable contact can be provided by an electromagnet, a solenoid, a pneumatic actuator, a motor or a simple mechanism such as a lever.

The invention described hereafter in more detail is designed to introduce a wiping (sliding), rocking and rolling action during the closing cycle of the electrical contacts. This action is designed to provide a variable electrical contact point/area and a peeling action should a weld have occurred. Equally, during the contact opening cycle there is a wiping, rocking and rolling action which also provides a variable contact point and peeling action.

The moveable bridge member of a double or multiple break contactor is conventionally set at 90 degrees to the longitudinal axes of fixed contact terminal posts. Either the moveable contact or the fixed contact posts, or both will have contact points with a spherical radius or will be configured such that a domed profile mates with either a flat contact surface or another domed shape. Thus when the contactor closes the contact is approximately at the middle point of the moveable contact. In the arrangement of the present invention the contactor has the moveable contact pad (or bridge member which carries the contacts) set at a tilt angle which departs from the usual 90 degree, square on orientation such that the initial contact point will be off the centre line of the moveable contact.

The relay or contactor according to the invention may be used for AC or DC power. It may have a moveable or bridging contact which, when in the open state, is angled at a lesser or greater angle than 90 degrees with respect to the centre lines of the fixed stud contacts or terminals.

The moveable contact (or bridging member) is assembled onto a shaft or plunger having any cross-section e.g. circular, rectangular, square or any regular or irregular shape.

When the contacts are in the open configuration, the moveable contact may be retained in its angled position either directly or indirectly by a spring and an angled, wedge-shaped head of the plunger.

During the closing stroke of the contacts it can be seen that initially the contact tips touch at or near their edges. Then as the closing stroke progresses the moveable contact begins to rotate (with the bridge) and the angular displacement approaches 90 degrees as the tilt is removed. Finally, towards the end of the closing stroke the moveable contact is positioned square to the fixed contact posts/studs and the tips make contact at or near to their centres. There may be additional movement of the shaft or plunger which retains the moveable contact, but this will not further affect the angular orientation of the moveable contact.

During the opening stroke of the contactor, the orientation of the moveable contact will be reversed: initially at 90 degrees, then progressively at an increasing tilt angle until at the end of the stroke the moveable contact is in its final angular position.

1. An electrical relay comprising a first member, a second member and an actuating mechanism for selectively bringing the first member into electrical contact with the second member by travel along an approach path between the members, wherein the first and second members are provided with at least one corresponding pair of associated electrical contact surfaces for making the electrical contact, which electrical contact surfaces are oriented with respect to the approach path and one another so as to be capable of forming a face-to-face abutment when brought into electrical contact,
wherein at least one electrical contact surface of one member is tilted by means of resilient biasing means relative to the corresponding electrical contact surface of the other member so that as the electrical contact surfaces are brought together along the approach path the electrical contact surfaces make an initial contact in the tilted orientation and as the members travel progressively together the movement of one member towards the other counteracts the biasing means so that the tilt reduces until face to face square-on contact is obtained as the electrical contact surfaces are urged together into electrical contact.

2. A relay as claimed in claim 1 wherein the electrical contact surfaces are each oriented so as to be generally perpendicular in orientation with respect to the approach path, subject to any applied tilt.

3. A relay as claimed in claim 2 wherein at least one of the electrical contact surfaces is tilted by biasing away from the perpendicular orientation.

4. A relay as claimed in claim 1 wherein the first member is a travelling contact member responsive to relay activation.

5. A relay as claimed in claim 4 wherein the second member is a fixed member up to which the contact member travels on actuation.

6. A relay as claimed in claim 5 wherein the travelling contact member is tilted by the resilient biasing means so as to cause the tilting of the associated at least one electrical contact surface.

7. An electrical relay comprising a contact bridge portion carrying at least two spaced apart electrical contact surfaces, a terminal portion comprising at least two corresponding spaced apart electrical contact surfaces, and an actuating mechanism for selectively bringing the electrical contact surfaces of the bridge portion into electrical contact with the electrical contact surfaces of the terminal portion by travel of one portion with respect to the other portion along an approach path between the portions, wherein the electrical contact surfaces of one portion are oriented with respect to the approach path and the electrical contacts of the other portion so as to be capable of forming a face-to-face abutment between electrical contact surfaces of the respective bridge and terminal portions,
wherein at least one electrical contact surface of one portion is tilted by means of resilient biasing means relative to the corresponding electrical contact surface of the other portion so that as the electrical contact surfaces are brought together along the approach path the electrical contact surfaces make an initial contact in the tilted orientation and as the portions travel progressively together the movement of one member towards the other counteracts the biasing means so that the tilt reduces until face-to-face square-on contact is obtained as the electrical contact surfaces are urged together into electrical contact.

8. A relay as claimed in claim 7 wherein the electrical contact surfaces are each oriented so as to be generally perpendicular in orientation with respect to the approach path, subject to any applied tilt.

9. A relay as claimed in claim 7 wherein at least one of the electrical contact surfaces is tilted by biasing away from the perpendicular orientation.

10. A relay as claimed in claim 7 wherein the bridge portion is provided with two spaced-apart contact surfaces, and there are two corresponding fixed terminal members in the terminal portion across which a circuit is made on actuation.

11. A relay as claimed in claim 10 wherein the bridge portion is tilted by the resilient biasing means so as to cause said tilting of the associated two spaced-apart electrical contact surfaces.

12. A relay as claimed in claim 7 wherein the actuation mechanism includes an actuation plunger which is attached to the bridge portion, the actuation plunger being arranged so as to be axially displaced along the approach path in response to actuation, thereby to displace the bridge portion into electrical contact.

13. A relay as claimed in claim 12 wherein the approach path comprises an actuation plunger longitudinal displacement axis.

14. A relay as claimed in claim 12 wherein the bridge portion comprises a bridge member which carries the two spaced apart contacts, which contacts are disposed generally perpendicular to the plunger displacement direction.

15. A relay as claimed in claim 14 wherein the bridge member is arranged to be capable of limited tilting with respect to the plunger, so that the electrical contact surfaces can tilt with the bridge member relative to the plunger travel direction.

16. A relay as claimed in claim 14 wherein a protruding feature is provided which is operative between the plunger and bridging member, which protruding feature displaces the bridging member from a perpendicular orientation to the tilted orientation.

17. A relay as claimed in claim 1 wherein one or more of the electrical contact surfaces has a domed configuration.

18. A relay as claimed in claim 1 wherein the electrical contact surfaces are provided by generally planar contact pads.

19. A relay as claimed in claim 1 wherein the approach path is a straight longitudinal displacement axis between the respective first and second members.

20. A relay as claimed in claim 7 wherein the approach path is a straight longitudinal displacement axis between respective bridge and terminal portions.
